(19) United States
(12) Patent Application Publication
(10) Pub. No.: US 2022/0091022 A1
(43) Pub. Date: Mar. 24, 2022

(54) Imaging of Biological Tissue

(71) Applicant: Technological University Dublin, Dublin (IE)

(72) Inventors: Aidan Meade, Dublin (IE); Frances Eileen Quigley, Dublin (IE); George Amarandei, Dublin (IE)

(21) Appl. No.: 17/309,806

(22) PCT Filed: Dec. 19, 2019
(86) PCT No.: PCT/EP2019/086398

§ 371 Date: Jun. 18, 2021

(30) Foreign Application Priority Data
Dec. 20, 2018 (GB) 1820796.9

(51) Int. Cl. G01N 21/21; G02B 1/08

(52) U.S. Cl. CPC G01N 21/21; G01N 2201/129; G02B 1/08

(57) ABSTRACT

We describe a method and a system for analysing a sample (12) using spectral polarimetry. The system comprises a light source, a first polarizer (22) having a first polarization angle for polarizing light from the light source, a second polarizer having a second polarization angle which is different to the first polarization angle, a birefringent component (20) which comprises a birefringent material, and a detector for receiving polarized light from the second polarizer (16). The birefringent component is positioned between the first and second polarizers and the sample is placed between the first polarizer and the second polarizer. The method comprises directing polarized light having a first polarization angle through a birefringent component which comprises a birefringent material, illuminating the sample with the light passing through the birefringent component, directing light through a polarizer having a second polarization angle which is different to the first polarization angle, and detecting the light transmitted through the polarizer.

### FIELD

The invention relates to a method and apparatus for imaging biological samples, including for example detecting changes in biological tissue to diagnose disease or predict reoccurrence following treatment.

### BACKGROUND

Tissue from patients may be analysed using imaging techniques to provide a non-invasive method for diagnosing and/or detecting illness or disease based on the optical anisotropy within the tissue. One important application is in cancer diagnosis and detection, particularly breast cancer, where there is a clinical need for detecting patients who may be at risk of recurrence. At least 60% of patients are at low to intermediate risk of breast cancer recurring following chemotherapy. Such patients are often not detected by costly commercial genetic tests and clinical studies have failed to identify useful characteristic biomarkers.

U.S. Pat. No. 8,649,008 describes a combined spectral and polarimetry apparatus for use in imaging and diagnostics. The apparatus comprises an imaging spectrometer which captures spatial and spectral information of an image of a target scene such as an ocular structure. The apparatus also has a polarimeter which comprises groups of polarizers and birefringent components and which can be used for channelled spectropolarimetry. The apparatus simultaneously records spatially co-registered spectral and polarization information from the image. US2011/0080586 describes an optical device having polarizer and retarders for spectroscopic polarimetry. The device allows a measurement error of a parameter showing a spectropolarization characteristic of a sample to be effectively removed.

Combined spectral and polarimetric imaging may also be applicable to other diseases that are characterised by inherent modifications to biological tissues.

The applicant has recognized the need for an alternative spectral polarimetry methods and/or device for imaging biological samples.

### SUMMARY

According to the present invention there is provided an apparatus and method as set forth in the appended claims. Other features of the invention will be apparent from the dependent claims, and the description which follows.

We describe a system for analysing a sample using spectral polarimetry, the system comprising a light source, a first polarizer having a first polarization angle for polarizing light from the light source, a second polarizer having a second polarization angle which is different to the first polarization angle, a birefringent component which comprises a birefringent material and which is positioned between the first and second polarizers, and a detector for receiving polarized light from the second polarizer, wherein the sample is placed between the first polarizer and the second polarizer. For example, the sample may be placed between the birefringent component and the second polarizer whereby light from the birefringent component passes through the sample before reaching the second polarizer. Alternatively, the sample may be placed between the first polarizer and the birefringent component whereby light from the sample passes through the birefringent component before reaching the second polarizer.

Polarimetry (or polarimetric imaging) may be defined as the measurement and interpretation of the polarization of transverse waves, in this example light waves may be used to measure the optical activity of a sample. In this case, the polarization may be caused by some or all of the first and second polarizers, the birefringent component and the sample. Spectral imaging is imaging that uses multiple bands across the electromagnetic spectrum, e.g. across the visible spectrum to cover red, green and blue light. For example, the light source may generate visible light and the detector may receive light over the visible spectrum. In the system described above, in use light passes from the light source to the first polarizer. In one arrangement, after the first polarizer, the light meets the standard birefringent material and then the light (which may optionally be focused through a lens) passes through the sample. Alternatively, after the first polarizer, the light meets the sample and may be optionally focussed through a lens onto the standard birefringent material. The light then passes through the second polarizer (which may also be termed an analyser) and then it goes to the detector.

We also describe a method of classifying a sample, the method comprising directing polarized light having a first polarization angle through a birefringent component which comprises a birefringent material, illuminating the sample with the light from the birefringent component, directing light transmitted through the sample through a polarizer having a second polarization angle which is different to the first polarization angle, and detecting the light transmitted through the polarizer. It will be appreciated that if the relative locations of the birefringent component and the sample are reversed, the method may comprise illuminating a sample with polarized light having a first polarization angle, directing light passing through a sample through a birefringent component which comprises a birefringent material, directing the light transmitted through the birefringent component through a polarizer having a second polarization angle which is different to the first polarization angle, and detecting the light transmitted through the polarizer.

The following features apply to both the method and system. The first polarizer may be at a right angle with respect to the first polarizer. For example, the first polarization angle may be 0° and the second polarization angle may be 90°. In other words, the first and second polarizers may be crossed and the two directions of polarization of perpendicular. When no sample or birefringent component is present and the polarizers are crossed, no light may be transmitted through the device. Once one of them is introduced, there is a change in polarization leading to a channelled spectrum. If only the sample is used, it is likely that very little light is passing through because the change in polarization provided by a typical sample (e.g. a tissue sample) is weak. Therefore, the system also includes a birefringent component to provide a channelled spectrum. Comparing the channelled spectra from two samples can be used to characterize them with reference to each other.

The birefringent component may be made from magnesium fluoride or any other suitable material e.g. quartz or polyester or any combination of materials. The effect of the birefringent component is known and thus together the birefringent component and the polarizers create an expected channelled spectrum. The sample may be birefringent or contain birefringent material and may thus affect the normal or expected channelled spectrum. There is no need for calibration of the system because the birefringence of the birefringent component is known.

When a sample with birefringence is inserted into the device, light will be transmitted and thus the change to the expected channelled spectrum may be observed. The channelled spectrum may be defined as the intensity of transmitted light which is recorded across the spectral region (e.g. the visible spectrum). The change occurs due to the fact that the light polarization will be rotated by the polarization axis of the sample, and so will not remain at the orientation it was when exiting the first polarizer, therefore enabling a proportion of it to transmit through the second polarizer. The angle of rotation, θ, that is observed, is related to the circular birefringence of the sample, An, the wavelength of the light, λ, and the length or thickness of the birefringent material, L as:

$$θ = \frac{π}{{λ}_{0}} Δ n . L$$

There may be a processor which is configured to classify the sample by determining changes to the received polarized light caused by the sample. In other words, there may be a determination of the changes to the expected channelled spectrum. A machine learning classifier (e.g. a multivariate classifier) may be used to classify the sample, e.g. to identify and differentiate different diseases that a patient from whom the sample has been taken may be suffering. The classifier may have multiple classes, e.g. high, low (and possibly one or more intermediate) risk groups indicating the level of risk that a patient having a disease which has been subject to a particular form of treatment is likely to see the return of the disease, e.g. the risk of recurrence of breast cancer following treatment with chemotherapy. Thus, the processor may be configured to determine the likelihood of particular (e.g. adverse or positive) clinical treatment outcomes for cancer in a patient (e.g. human or animal) from whom the sample has been taken. The processor may be configured to use a machine learning technique which has been trained using samples for which biological or clinical treatment outcomes for cancer therapy (or other therapies) are known.

The sample may be a tissue sample from a human or an animal. For example, the sample may be a formalin fixed, paraffin preserved tissue sample and may contain wax, or may be preserved by another method, including, but not limited to, OCT, snap freezing, etc.

We also describe a method of diagnosing a disease, e.g. cancer in a patient from a sample, the method comprising classifying the sample as described above, and diagnosing the disease based on the classification. For example, the classification may be one of a high, low (and possibly one or more intermediate) risk group indicating the level of risk that a patient has a particular disease, e.g. breast or oesophageal cancer, based on the sample.

We also describe a method of predicting a response to a cancer treatment in a patient from a sample, the method comprising classifying the sample as described above, and predicting the likelihood of recurrence of the cancer based on the classification. For example, the classification may be one of a high, low (and possibly one or more intermediate) risk groups indicating the level of risk that a patient having a disease which has been subject to a particular form of treatment is likely to see the return of the disease, e.g. the risk of recurrence of breast cancer following treatment with chemotherapy.

We also describe a method of selecting a treatment for a patient, the method comprising classifying the sample as described above, and selecting a treatment based on the classification. For example, the classification may be one of a high or a low (and possibly one or more intermediate) response groups indicating the likelihood that a patient will respond well to a particular form of treatment or equally be in a high, medium or low group at risk of an adverse response to the treatment. The method may further comprise treating the patient with the selected treatment. Accordingly, we also describe a method of treatment. The personalised tailoring of therapy options in various cancer types may thus be a potential outcome.

Although a few preferred embodiments of the present invention have been shown and described, it will be appreciated by those skilled in the art that various changes and modifications might be made without departing from the scope of the invention, as defined in the appended claims.

### BRIEF DESCRIPTION OF THE DRAWINGS

For a better understanding of the invention, and to show how embodiments of the same may be carried into effect, reference will now be made, by way of example only, to the accompanying diagrammatic drawings in which:

FIG. 1 is a schematic illustration of the apparatus;

FIG. 2a is a schematic illustration of the effect of the two polarisers and the wave plate;

FIG. 2b is a graph plotting the channelled spectrum, i.e. the change in intensity with wavelength, for the apparatus of FIG. 1 with a sample present; and

FIG. 3 is a flow chart showing the steps in the method.

### DETAILED DESCRIPTION OF THE DRAWINGS

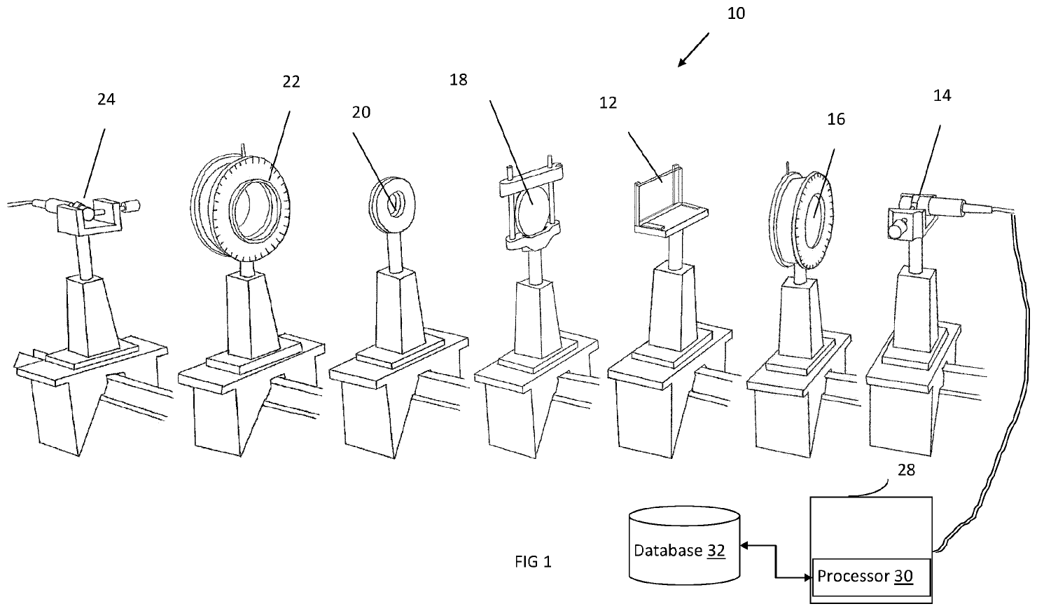

FIG. 1 shows a combined spectral and polarimetric apparatus 10 for analysing a sample 12, e.g. a planar biological sample, to analyse intrinsic polarization changes within the sample which may be helpful in diagnosis or detection of illness or disease. The sample may be a tissue sample which may be a standard sample using formalin-fixed, paraffin preserved tissue. The imaging process can be used on any sample and thus in contrast to some imaging techniques, such as spectral histopathology using Raman or FTIR imaging, or certain kinds of immunohistochemistry, there is no need to remove any wax used in the sample through chemical or digital de-waxing. Accordingly, a normal step in the pathology workflow may be eliminated using the technique described below. The present imaging technique can be performed prior to H&E (haematoxylin and eosin) staining, immunochemical staining or similar techniques. Thus, the tissue can be used for several tests without being destroyed.

The sample is imaged by passing light from a probe fibre 24 through the sample. Before the light reaches the sample, the light is passed through a first polarizer 22. The polarizer is for example set to 0°. Polarized light is optionally focussed by a lens 18 on the sample 12. Each of the probe fibre 24, the polarizer 22 and the lens 18 may be standard and widely available optical components. For example, the probe fibre may be connected to any suitable broadband light source, which may have a continuous output at wavelengths across the visible region of the spectrum, e.g. a white source tungsten lamp, a hyperspectral white LED or a plasma spectroscopic light source.

Between the first polarizer 22 and the lens 18 is a birefringent component 20 (which may also be termed a retarder or a waveplate) made from a standard birefringent material. Examples of suitable materials include magnesium fluoride, polyester, birefringent polymers and birefringent crystals such as quartz. Birefringent materials are optically anisotropic, i.e. have an optical property with a different value when measured in different directions. More specifically, the material has a refractive index that depends on the polarization and propagation direction of light. The anisotropy of the material polarizes the light in a certain direction and the angle of polarization is known because the nature of the birefringence for the material is known. The material may be cleaved to form a plane about which light will be polarized. The cleaving angle is another known parameter. The birefringent material may reduce the light intensity for some wavelengths in the spectrum. As two illustrative different examples, the birefringent component may comprise a 0.18 mm thick polyester film or a magnesium fluoride crystal which is 2 mm thick and, cut perpendicularly to the optical axis to maximize its birefringence.

The light then passes from the sample 12 through a second polarizer 16 which may also be termed an analyser. The second polarizer 16 is set at a right angle, e.g. at 90°, compared to the first polarizer. In other words, the first and second polarizers are used in a crossed configuration. As with the first polarizer 22, the second polarizer 16 may be a standard optical component. The first and second polarizers are fixed at the first and second polarization angles respectively. In other words, the polarizers are not rotated during analysis of the sample and no rotation angle is measured unlike other systems such as U.S. Pat. Nos. 6,246,893, 5,045,701 which use rotatable polarizers.

The polarized light then passes to a detector in the form of a detection fibre 14. Any suitable detector may be used, for example if the source produces light across the whole visible spectrum, the detector may be configured to detect light in the visible spectrum, e.g. in the range of about 400 nm to 800 nm. Using visible light may result in less costly components and may also be the most useful part of the spectrum for tissue samples from animal or human patients. However, it will be appreciated that the components may be changed so that other parts of the spectrum may be used where appropriate for the sample being examined, e.g. ultra-violet, infra-red or terahertz regions (for example).

As shown in the arrangement, the light is at one end of the apparatus and the detector is at the opposite end of the apparatus with the sample placed between the light source and the detector. More specifically, the sample is placed between the two polarizers. The birefringent component is also between the two polarizers. In the arrangement shown, the sample may be placed between the birefringent component and the second polarizer whereby light from the birefringent component passes through the sample before reaching the second polarizer. Alternatively, the sample may be placed between the first polarizer and the birefringent component whereby light from the sample passes through the birefringent component before reaching the second polarizer. Light passes along an optical path through each of the components. The direction of light travel is from the light source to the detector and thus the first polarizer may be considered to be upstream from the second polarizer (or the second polarizer may be considered to be downstream from the first polarizer).

The orientation of polarization provided by the two polarizers and the birefringent component is known. It will be appreciated that other ranges may be used but the baseline (i.e. minimum) and the maximum value of the angle of polarization provided by the polarizers need to be known. In this example, the baseline is 0° and the maximum value is 90°. Similarly, the orientation of polarization provided by the birefringent component is known. In this configuration the device therefore has three reference polarizations: (i) the 90° polarizer, (ii) the 0° polarizer and (iii) the birefringent reference material. The device therefore needs no calibration. Additionally, while the birefringent materials will each have a channelled spectrum, the inclusion of the tissue sample within the beam will ‘shift’ the channelled spectrum, and it is this shifted spectrum which is then used for the classification analysis here.

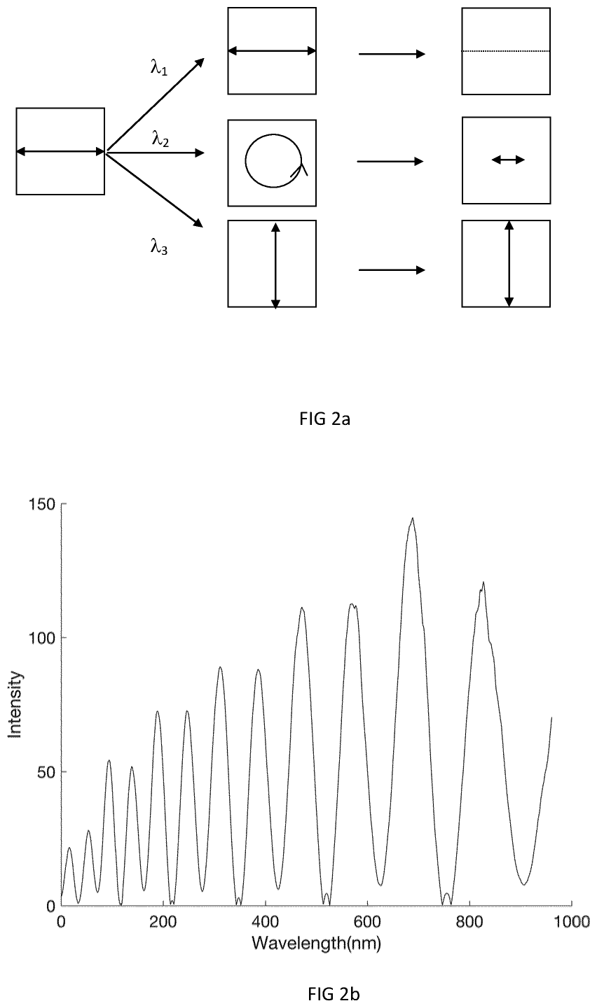

The knowledge of the polarization effects of both polarizers and the birefringent component means that no calibration of the device is needed. The use of a birefringent component of birefringent material between two polarizers generates a channelled spectrum as explained in more detail with reference to FIGS. 2a and 2b. The detector may be configured to detect the intensity of light for each wavelength in the spectrum (i.e. in the visible light spectrum for this example) which has passed through the apparatus. It is sufficient to use the knowledge of the polarization provided by the polarizers and the birefringent component to calculate (identify or determine—the words can be used interchangeably) any additional polarization produced by the sample that leads to changes to the channelled spectrum of the birefringent material. In other words, the spectral data can be used by a spectral analyser 28 which is connected to the detector and which contains a processor 30 which can be used to obtain useful information regarding the biological sample. The useful information may include generating the likelihood of a particular classification applying to the sample, for example by comparing the change introduced by the sample to other known and classified samples. Accordingly, the processor/analyser may be connected to a database 32 which stores known values and/or classified samples.

The components described above may use widely available standard optical components. The configuration above could be retrofitted onto existing optical (and potentially spectroscopic) microscopes in pathology laboratories, potentially improving the potential for its uptake by clinical laboratories. Furthermore, the two polarizers and the birefringent component may be the only components which are needed to generate the necessary channelled spectrum and thus the polarizing section of the system may be considered to consist of these components.

FIG. 2a illustrates how light passes through the two polarizers and the birefringent component. In addition to the change to the polarization by the polarizers and birefringent component, the sample itself may change the polarization if it contains birefringent material. The polarized light passing through the sample will be rotated by the polarization axis of the sample, and so will not remain at the orientation it was when exiting the first polarizer, therefore enabling a proportion of it to transmit through the second polarizer. The angle of rotation, 0, that is observed, is related to the circular birefringence of the sample, An, the wavelength of the light, λ, and the length or thickness of the birefringent material, L as:

$$θ = \frac{π}{{λ}_{0}} Δ n . L$$

Considering just one birefringent material between the two polarizers (i.e. either the sample or the birefringent component), for certain wavelengths, the angle of rotation, 0, that is observed will be an even multiple of π, i.e. θ=2mπ, and the light which is at 0° of linear polarization after passing through the first polarizer will be unchanged by the birefringent component. Given that the second polarizer is perpendicular to the first polarizer, no light will be transmitted through the second polarizer, i.e. the light beam will be totally intercepted. This outcome is illustrated by λ₁ in FIG. 2a. For other wavelengths, the angle of rotation, θ, will be an odd multiple of a, i.e. π, i.e. θ=2mπ, and thus the 0° linearly polarized light is transformed or shifted into 90° linearly polarized light. This light beam which is illustrated by λ₃ in FIG. 2a will pass completely through the second polarizer. For other wavelengths, the effect will be somewhere between these two extremes. For example, as illustrated by λ₂ in FIG. 2a, the angle of rotation, θ, is no longer an integer multiple of π, i.e. θ=(2m=1)π/2. In this intermediate case, the 0° linearly polarized light is transformed into a right or left-circular polarization and the light beam is then partially transmitted through the second polarizer. Thus, the total transmissions and interceptions occur alternatively with respect to wavelength and the output spectrum becomes channelled. In general, the spectrum can be channelled more frequently in the shorter wavelength range than in the longer one.

Given that the effect of the birefringent component is known, any changes to the expected channelled spectrum must be caused by the sample. Accordingly, the difference between the expected channelled spectrum and the received channelled spectrum can be calculated and used as explained below.

FIG. 2b shows a channelled spectrum for the apparatus of FIG. 1 measuring a tissue sample. As shown a channelled spectrum is a series of bright and dark fringes or of minima and maxima. In this example, polyester is used in the birefringent component. Once this channelled spectrum is recorded, the circular birefringence of the sample may be characterised in terms of its variation with wavelength, in addition to parameters including dispersion and Mueller matrix components, all of which are not used here, but could be used in other embodiments.

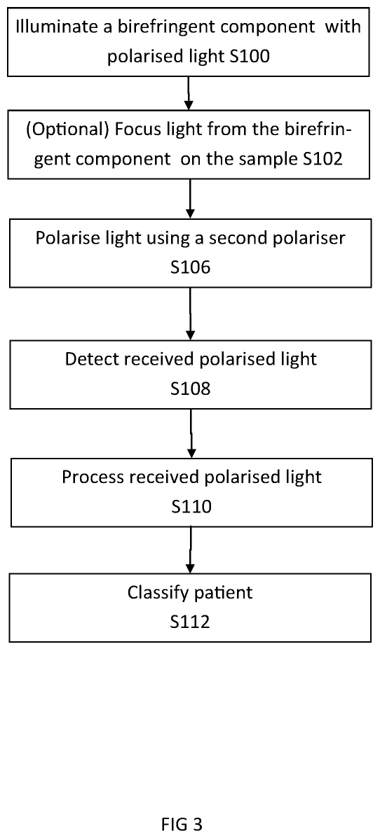

FIG. 3 is a flowchart showing the steps in a method using the apparatus described above. In a first step, a birefringent material such as the birefringent component described above is illuminated with polarized light (S100). As illustrated above, the polarized light may be created by passing light from a white light source through a polarizer set at 0°. It will be appreciated that this is just one example of a suitable value for the polarization. The birefringent material may alter (e.g. rotate or polarize) the polarized light from the first polarizer by a known polarization amount. Optionally, the light which passes through and out of the birefringent material may be focussed on a sample such as the biological sample described above, e.g. using a lens (S102). As the light passes through and is thus transmitted by the sample, the oscillating wavelengths in the light spectrum may be altered by the sample. The sample may contain birefringent material, e.g. elastin and collagen, which may change the polarization of the polarized light as it passes through the sample.

The transmitted light may then be polarized (or analysed) using a second polarizer (S104) which as explained above may be set at a right angle to the first polarizer. Polarized, transmitted light is then received at a detector which detects the received light (S108). The received light which has been polarized by the two polarizers, the birefringent component and possibly the sample is then processed by the spectral analyser (S110).

It will be appreciated that if the relative locations of the birefringent component and the sample are reversed, the received light has still been polarized by the two polarizers, the birefringent component and possibly the sample. However, the steps of the method will be altered so that the sample is illuminated with polarized light having a first polarization angle. Light passing through a sample will then be directed through a birefringent component which comprises a birefringent material. The light transmitted through the birefringent component is then analysed using a polarizer having a second polarization angle which is different to the first polarization angle. Finally, as before the analysed light is detected and may then be processed by the spectral analyser (S110).

For example, the processing may include identifying the changes in the channelled spectrum which result from the sample itself. The changes which are identified may then be used to classify the patient from whom the sample has been taken or to identify biological information about the patient (S112). For example, the patient may be classified (i.e. stratified) into one of a plurality of risk groups. There may be high, low (and possibly one or more intermediate) risk groups indicating the level of risk that a patient has a particular disease, e.g. breast or oesophageal cancer, based on the sample. Alternatively, there may be high, low (and possibly one or more intermediate) risk groups indicating the level of risk that a patient having a disease which has been subject to a particular form of treatment is likely to see the return of the disease, e.g. the risk of recurrence of breast cancer following treatment with chemotherapy. Alternatively, there may be high, low (and possibly one or more intermediate) response groups indicating the likelihood that a patient will respond well or adversely to a particular form of treatment.

The classification of patient samples may be done by comparing the change introduced by the sample to other known and classified samples. Suitable techniques include, but are not limited to, models based on information based learning (e.g. decision trees), similarity based learning (e.g. nearest neighbour algorithms), probability based learning (e.g. Bayesian methods or discriminant analysis), error based or statistical learning (such as multivariate regression or support vector regression) or neural networks. For example, machine learning techniques which have extracted factors from known samples can then be compared with a sample to be analysed. In other words, the channel spectra can thus be used to create a multivariate classifier which classifies the tissue (and hence the patient) into a plurality of a particular biological outcomes. Suitable techniques include PCA (principal component analysis) and/or LDA (linear discriminant analysis). A training set of samples having known clinical outcomes may be used to train the machine learning system so that the machine learning system can differentiate the changes in the channelled spectrum caused by a sample from a patient having one clinical outcome from those caused by a sample from a patient having one clinical outcome.

For example, the training may be performed for a plurality of breast cancer tissue samples in which the recurrence history is known, i.e. for a number of samples in which recurrence did occur and a number of samples in which recurrence did not occur. The change(s) to the channelled spectra caused by the sample may thus be considered to be a set of biomarkers which may be used to segregate patients. As an example to validate the methodology, breast cancer tissue from a cohort of 144 Swedish patients described in “miR-187 is an independent prognostic factor in Breast Cancer and Confers Increased Invasive Potential In Vitro” by Mulrane et al published in Clinical Cancer Research 2012, 18:6702-6713 were used as training data. Breast cancer tissue was acquired from this cohort and preserved via formalin fixation and paraffin preservation. In addition the patients from whom the tissue was taken were followed for up to 7 years post treatment, with various pathologic and clinical variables recorded for each patient, including whether cancer recurred over this timeframe. The spectra from each tissue specimen were recorded and used within machine learning algorithms (including discriminant analysis, decision tree and statistical learning algorithms) to classify patients into those in whom no cancer recurrence was observed and those in whom recurrence was observed, on the basis of their channelled spectrum. Rates of classification were over the range from 83% to 93% depending on signal quality, whether a polyester film or crystal is used as a reference material, and on presentation of data to the algorithm.

As set out above, there may be no need to remove the wax from the sample. This may be achieved by training the machine learning algorithm or otherwise comparing with known samples that have the wax therein.

The techniques described above have the potential to improve the clinical interpretation of the image, e.g. by using machine learning techniques which are less dependent on the competence of an individual analysing the image. The analysis also uses the raw data which is acquired by the system (i.e. the light which is detected after passing through various components). By using the raw data, the need to calculate the quasi-Stokes parameters and/or Mueller matrix or to use Fast-Fourier Transforms as described for example in US2011/0080586, U.S. Pat. No. 5,045,701 or WO2007/120181 may be avoided.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A system for analysing a sample using spectral polarimetry, the system comprising
a light source,
a first polarizer having a first polarization angle for polarizing light from the light source,
a second polarizer having a second polarization angle which is different to the first polarization angle,
a birefringent component which comprises a birefringent material and which is positioned between the first and second polarizers,
a detector for receiving polarized light from the second polarizer, and
a processor which is configured to classify the sample by determining changes to the received polarized light caused by the sample,
wherein the sample is placed between the first polarizer and the second polarizer.

2. The system of claim 1, wherein the processor is configured to use a machine learning classifier to classify the sample.

3. The system of claim 1, wherein the processor is configured to determine the likelihood of particular clinical treatment outcomes in a cancer patient from whom the sample has been taken.

4. The system of claim 1, wherein the processor is configured to use a machine learning technique which has been trained using samples for which biological or clinical treatment outcomes for cancer therapy are known.

5. The system of claim 1, wherein the sample is placed between the second polarizer and the birefringent component whereby light from the birefringent component passes through the sample.

6. The system of claim 1, wherein the first polarizer and the second polarizer are crossed.

7. The system of claim 1, wherein the birefringent component is made from magnesium fluoride.

8. The system of claim 1, wherein the sample is a tissue sample.

9. The system of claim 1, wherein the light source generates visible light and the detector receives light over the visible spectrum.

10. A method of classifying a sample, the method comprising
directing polarized light, from a first polarizer, having a first polarization angle through a birefringent component which comprises a birefringent material,
illuminating the sample with the light passing through the birefringent component,
directing light through a second polarizer having a second polarization angle which is different to the first polarization angle,
detecting the light transmitted through the polarizer, and
classifying the sample by determining changes to the detected light caused by the sample.

11. The method of claim 10, comprising using a machine learning classifier to classify the sample.

12. The method of claim 10, comprising determining the likelihood of particular treatment outcomes in a cancer patient from whom the sample has been taken.

13. The method of claim 10, comprising using a machine learning technique which has been trained using samples for which biological and/or clinical outcomes are known.

14. The method of claim 10, wherein the first polarization angle and the second polarization angle are perpendicular to each other.

15. A method of diagnosing a disease in a patient from a sample, the method comprising:
classifying the sample according to claim 10, and
diagnosing the disease based on the classification.

16. A method of predicting disease response to a cancer treatment in a patient from a sample, the method comprising classifying the sample according to claim 10, and predicting the likelihood of recurrence of the cancer based on the classification.

17. A method of selecting a treatment for a patient, the method comprising
classifying the sample according to claim 10, and
selecting a treatment based on the classification.

18. The system of claim 1,
wherein the first polarizer is configured to provide a first known polarization effect;
wherein the second polarizer is configured to provide a second known polarization effect;
wherein the birefringent component is configured to provide a third known polarization effect;
the processor which is configured to classify the sample by determining changes to the received polarized light caused by the sample by comparing an expected channelled spectrum to the received polarized light,
wherein the expected channelled spectrum is generated by a combination of the first known polarization effect and the second known polarization effect and the third known polarization effect.

19. The method of claim 10, further comprising:
classifying the sample by determining changes to the detected light caused by the sample by
comparing an expected channelled spectrum to the detected light;
providing a first known polarization effect by the first polarizer;
providing a second known polarization effect by the second polarizer;
providing a third known polarization effect by the birefringent component; and
generating the expected channelled spectrum by combining the first known polarization effect and the second known polarization effect and the third known polarization effect
